(19) United States
(12) Patent Application Publication
(10) Pub. No.: US 2006/0059746 A1
(43) Pub. Date: Mar. 23, 2006

(54) Frame for fitting a smart card connector onto a panel

(76) Inventors: Fabrice Valcher, Dole (FR); Bruno Michel, Dole (FR); Sylvain Rochon, Dole (FR)

Correspondence Address: LEON D. ROSEN;FREILICH, HORNBAKER & ROSEN, Suite 1220, 10960 Wilshire Blvd., Los Angeles, CA, 90024, US

(21) Appl. No.: 11/178,865

(22) Filed: Jul. 11, 2005

Related U.S. Application Data
(63) Continuation-in-part of application No. PCT/EP04/50008, filed on Jan. 9, 2004.

(30) Foreign Application Priority Data
Jan. 14, 2003 (FR) FR 0300333

(51) Int. Cl. G09F 21/04

(52) U.S. Cl. 40/593

(57) ABSTRACT

A frame (14) that includes a smart card connector (12), is mounted primarily behind a window (18) in a panel (16) so a smart card can be inserted rearwardly though the window and against contacts that read and/or write to the card. The panel has window edge portions that lie around the window, and the frame includes a pair of lugs (42) that are projected into the window and that are then raised so lug slots (45) receive an upper edge portion of the window. The frame also has a pair of fingers (60) that are resiliently biased forwardly, that press against the rear of the panel when the lugs are first projected into the window, and that snap forward and lie against window lower edge portions when the lugs are raised. The fingers lie at the ends of laterally extending beams that project from a main portion of the frame. The lugs and fingers form ramps (56, 78) that vertically guide the leading edge of a card being inserted, and the lugs form side guides (112).

This is a continuation-in-part of PCT/EP2004/050008 filed Jan. 9, 2004, which claimed priority from French application no. 0300333 filed Jan. 14, 2003.

### BACKGROUND OF THE INVENTION

A smart card connector sometimes must be mounted on a panel that has a slot through which the smart card can be inserted. The connector is part of, or mounted on a frame that should be easily mounted on the panel and should hold itself securely to the panel. Such frame should have a minimum number of parts and perform the functions of guiding a card into a slot where contacts engage contact pads of the card.

### SUMMARY OF THE INVENTION

In accordance with one embodiment of the invention, a frame is provided that holds smart card connector contacts and that is constructed to hold itself to a slot in a panel so a smart card can be inserted rearwardly through a window in the panel to engage the contacts. The frame is of the type that has lugs that can be inserted into the window and then raised so lug slots receive panel window edges, with fingers of the frame then snapping into the window to lie against the bottom of the window edge. The fingers lie at the ends of primarily laterally-extending long beams that biased the fingers rearwardly. The beams are part of an X-shaped beam structure that includes two rear beams with laterally spaced mounted rear ends and with front ends that are fixed together in a joint, and that also includes two front beams that extend laterally away from the joint and that have free ends that carry the fingers.

The lugs form opposite side guides for guiding the card into a card-receiving slot. The lugs and fingers form ramps that guide the leading edge of a card vertically into the slot. The free ends of the beams on which the fingers are mounted, form stops that lie below the fingers and that abut the rear face of the panel immediately below the fingers.

The novel features of the invention are set forth with particularity in the appended claims. The invention will be best understood from the following description when read in conjunction with the accompanying drawings.

### BRIEF DESCRIPTION OF THE DRAWINGS

FIG. 1 is an isometric view of a frame assembly, or frame constructed in accordance with the invention.

FIG. 2 is an elevation view of a front of a panel with a window therein, into which the frame of FIG. 1 can be installed.

FIG. 3 is bottom view of the frame of FIG. 1, shown installed on the panel of FIG. 2, and with a smart card fully installed in the frame.

FIG. 4 is a bottom view of the frame of FIG. 1, but without the card.

FIG. 5 is a sectional view taken on line 5-5 of FIG. 4.

FIG. 6 is a view taken along arrow F6 of FIG. 4.

### DESCRIPTION OF THE PREFERRED EMBODIMENT

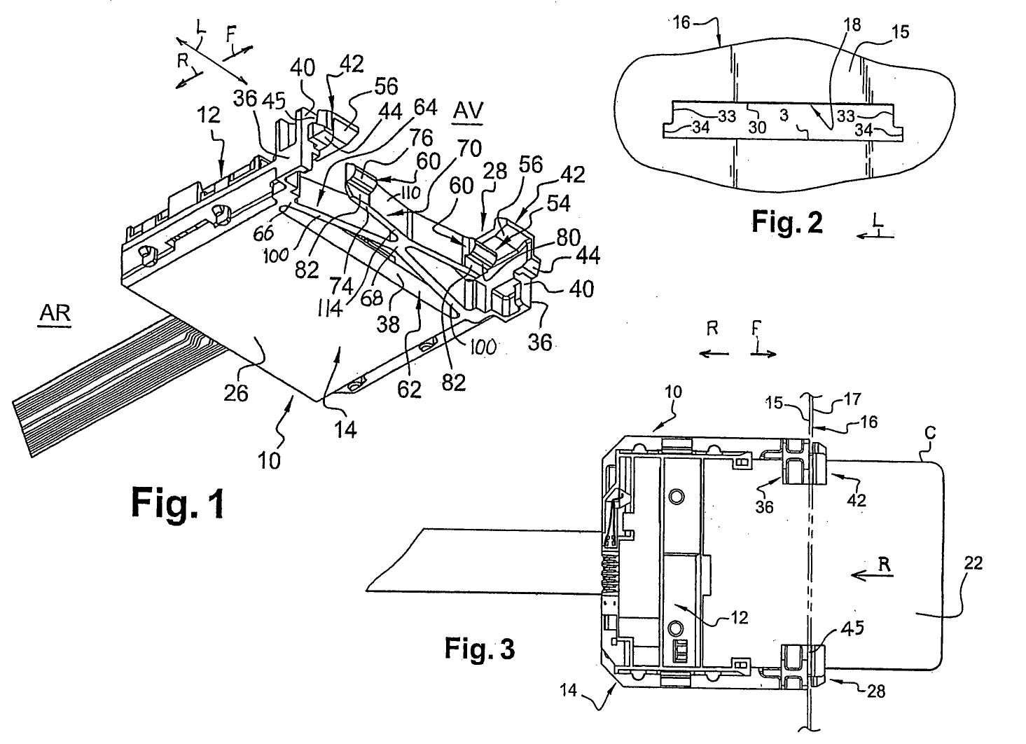

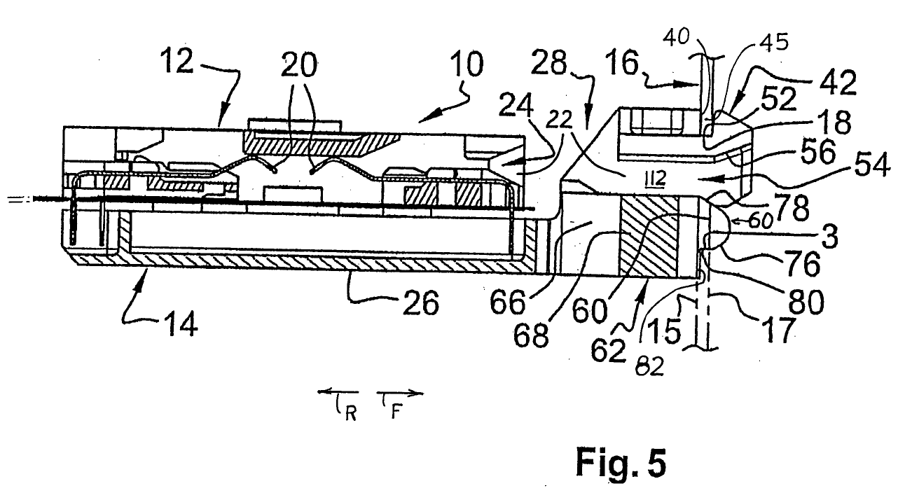

FIG. 1 shows an assembly 10 for receiving a smart card, which includes a molded plastic frame 14 that supports a connector or that includes a connector portion 12 that is integral with the frame. The frame is constructed for mounting in a window 18 (FIG. 2) of a panel 16. FIG. 5 shows the frame mounted in the panel window, and shows that the frame forms a card-receiving slot 22 with slot parts 24, 54 that receive a smart card C (FIG. 3) that is inserted in a rearward direction R though the panel window. The card has contact pads (not shown) on its lower surface 22 (FIG. 3), and the frame has contacts 20 (FIG. 5) in the form of contact blades, that engage the card contact pads. The frame includes a horizontal plate-shaped rear part 26 that includes the connector or connector portion 12, and also includes a front part 28 that is constructed to mount to the walls of the panel window.

The window 18 of FIG. 2 is of a known shape, and includes horizontally extending upper and lower edges 30, 31 and vertically extending edges 33. A lower part of the window has notches 34 at laterally L opposite sides of the window.

The front part 28 (FIG. 1) of the frame includes a pair of forward projections 36 with upper ends that extend above the level of the frame rear part 26 and that project forward and upward from laterally opposite sides of the frame rear part. The front projections form a pair of end faces 40 that face forwardly and that are intended to abut the rear face of the panel. Each forward projection also has a locking lug 42 with a tab 44. Each lug forms an upwardly and sidewardly-opening slot 45 that lies between the end face 40 and a rear of the lug. The tabs 44, which have inclined lower and upper surfaces 44, 49 (FIG. 6) help guide the lugs into the window by passing though the notches 34 of the window.

Initially the frame is at a slightly lower position relative to the panel window 18 than is shown in FIG. 5. In this position, the lugs 42 are inserted into the window until the end faces 40 abut the rear surface 15 of the panel. Then, the entire frame, including the lugs are raised, so slots 45 in the lugs receive upper and side edge portions of the window. Slot locations behind the tabs 44 of the lugs receive window edge portions 33 (FIG. 2) that lie above the notches. The lug portions lying laterally inward of and above the tabs receive the window upper edge portions 30. In this position, walls at the bottom of the lug slots 45 abut the top edge portions 30 of the window.

When the lugs are raised as described above, a pair of locking fingers 60 (FIG. 1) snap into the window and lie against the lower edge portion 31 of the window. The locking fingers are formed at free ends of an elastic beam structure 62 that is largely in the form of an X. The beam structure includes a rear branch 64 having two rear beams 100 that extend primarily in a lateral direction L. The rear beams have laterally spaced (by a majority of the frame lateral width) mounted end 66 that are each fixed to the rear part 26 of the frame. The rear beams extend laterally toward the lateral middle of the frame and have front ends that merge in a joint 68. The beam structure also has a front branch 70 that includes a pair of forward beams 110 that extend primarily laterally and that each has a rear end 114 that merges with the joint 68. The front beams extend primarily laterally away from the joint and from each other, and each has a free front end 74 that forms one of the locking fingers 60.

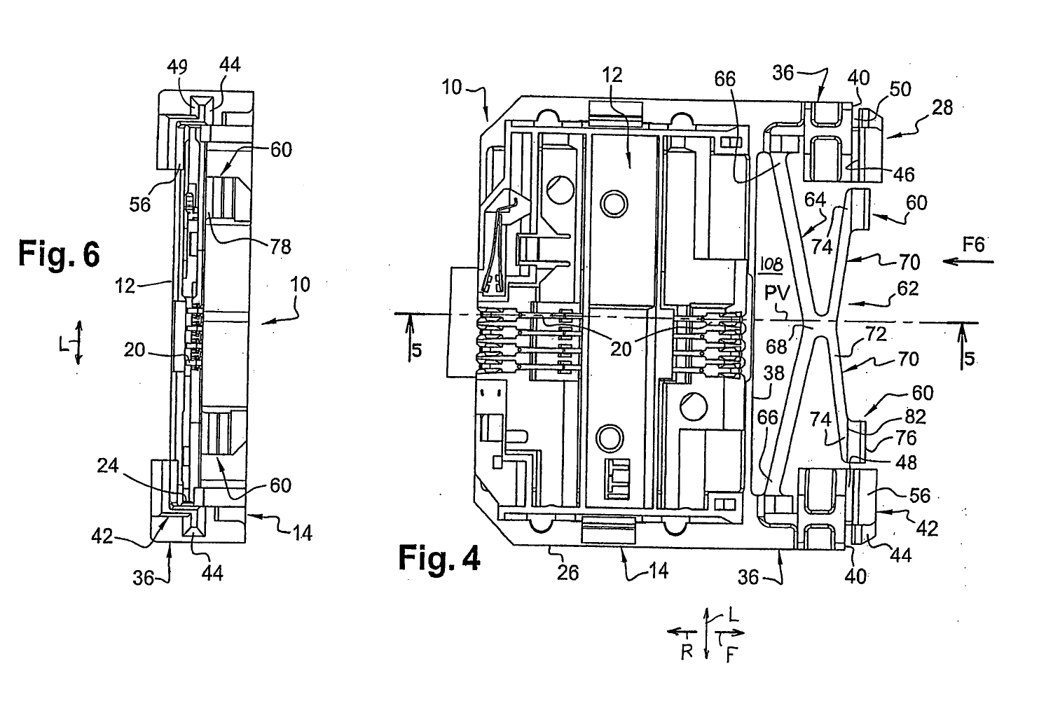

Thus, each locking finger is carried by an elastic beam that can be said to include one rear beam 100 and one front beam 110 and that together have a lateral length at least half the average lateral width of the frame and that lie in a wide space 108 (FIG. 4) between the forward projections 36 that form the lugs. The front beams 110 allow the fingers 60 to pivot slightly about horizontal axes, to ride over the lower edge 31 of the window as the fingers snap into the window and to thereafter press down against the window. As shown in FIG. 5, each finger has a front face 76 with inclined top and bottom surfaces 78, 76, and in the form of an arc of a cylinder that has a horizontal axis. The upper part 76 of the front face forms a ramp that extends at a rearward-upward incline. This ramp helps guide the leading edge of a card that is being inserted, up into the rear slot portion 54. The lugs 42 form ramps 56 on their tabs, that extend at rearward-downward inclines to guide the leading edge of a card downward into the rear slot portion. The lugs also form side guides 112 at sides of the lugs that face each other, to guide the sides of a card that is being inserted.

The bottom 80 of each finger extends horizontally and lies against the lower edge portion of the window, preferably by pressing against it. Each front beam free end has a lower stop face 82 that is substantially coplanar with the front face 40 of the projections, and which bear against the rear surface of the panel.

Although terms such as “upper” and “lower” have been used to describe the invention as it is illustrated, it should be realized that the frame can be used in any orientation.

Thus, the invention provides a frame that holds contacts that engage contact pads of a smart card, which can be easily and securely mounted in a window of a panel, and that has a minimum number of simple parts. The frame includes a pair of laterally spaced lugs that are inserted into the window and raised to receive upper window edge portions, and includes fingers that snap into the window as the frame is raised to abut lower window edge portions. The fingers are mounted at the free ends of beans that extend primarily laterally. The beams are preferably parts of an X-shaped structure that includes primarily laterally-extending rear beams joined at a joint and a pair of front beams extending primarily away from each other to free ends that form the fingers. The fingers and lugs form ramps that guide the leading edge of a card being inserted. The lugs form side guides that guide the sides of a card being inserted.

The novel features of the invention are set forth with particularity in the appended claims. The invention will be best understood from the following description when read in conjunction with the accompanying drawings.

What is claimed is:

1. A frame for mounting a smart card connector portion behind a window of a panel to receive a smart card that is inserted rearwardly through the window, the panel having window edge portions at said window, said frame having a rear portion and having a pair of laterally spaced lugs projecting forward from laterally opposite sides of said rear portion, said lugs having upwardly opening slots for receiving upper window edge portions when the lugs are inserted forward into the window and then raised, and said frame having a pair of deflectable beams with forward free ends forming a pair of fingers, the fingers snapping forward into lower portions of said window when said lugs are raised and said fingers having lower faces that bear against lower one of said window edge portions, wherein:
said frame forms a largely X-shaped beam structure that includes two rear beams with laterally opposite mounted ends fixed to said frame rear portion and having merging ends that merge into a joint, and that has two front beams that have mounted ends that merge with said joint, said front beams extending laterally away from each other and have free ends to which said fingers are fixed, said front beams forming portions of said pair of deflectable beams.

2. The frame described in claim 1 wherein:
said frame forms a card-receiving slot that leads to said contact blades;
each of said fingers has a top surface that extends at an upward-rearward incline and that is positioned to form a ramp that guides the leading edge of a card upward into said card-receiving slot; and
each of said lugs has a lower surface that extends at a downward-rearward incline and that is positioned to form a ramp that guides the leading edge of a card downward into said card-receiving slot.

3. The frame described in claim 1 wherein:
each of beams has a stop that abuts the rear face of the panel immediately below the corresponding finger.

4. The frame described in claim 1 wherein:
said lugs form opposite side guides that guide opposite sides of a card that is inserted rearwardly through the window.

5. The frame described in claim 1 wherein said window has laterally opposite sides with lower ends that each forms a notch, and wherein:
said lugs each form tabs of smaller height than said notches, said tabs projecting laterally away from each other and having inclined upper and lower tab surfaces.

6. A frame that includes a smart card connector and that is mounted in an opening, or window of a panel, the frame defining a card-receiving slot for receiving a smart card, wherein said frame includes a frame rear portion that lies rearward of said panel and said frame includes a frame front portion that has laterally opposite forward projections that project forwardly through said window and that form slots that receive edge portions of the panel that lie around said window when the frame is lifted, said frame also including a plurality of fingers that are each resiliently biased forward to lie against a lower edge of said window when said frame is lifted, wherein:
said frame includes a pair of primarily laterally extending beams that lie between said forward projections and that have free ends that form said fingers.

7. The frame described in claim 6 wherein:
said laterally opposite forward projections form a space between them that has a lateral width of at least half the average lateral width of said frame;
said beams each extends laterally along at least half of said width of said frame.

8. The frame described in claim 6 wherein:
said frame has a rear portion that forms a X-shaped beam arrangement that includes a rear pair of beams with laterally spaced first beam ends that each merges with said frame rear portion and with second beam ends that merge with each other at a joint, said X-shaped beam arrangement having a front pair of beams with first ends that merge with said joint and with laterally spaced second ends on which said fingers are mounted.

9. The frame described in claim 6 wherein said frame has a pair of primarily laterally extending beams with free ends, said fingers being mounted on said free ends, and wherein:
said beam free ends have stops that each abuts said panel at a location adjacent to a corresponding one of said fingers.

10. A frame that includes a smart card connector and that is mounted in an opening, or window of a panel, the frame defining a card-receiving slot for receiving a card having opposite side edges and having a plurality of contacts that engage contact pads on the smart card, wherein said frame includes a frame rear portion that lies rearward of said panel and said frame includes a frame front portion that has a pair of lugs that project forwardly through said window and that form slots that receive edge portions of the panel that lie around said window, said frame also including a plurality of fingers that are each resiliently biased toward a position wherein a face of the finger abuts a lower edge of said window, wherein:
said lugs form opposite side guides that are positioned to guide said opposite side edges of said card during card insertion;
said lugs and fingers form ramps that are positioned to guide a card leading edge to the height of the card-receiving slot.

11. The frame described in claim 10 wherein:
said frame has a rear portion that forms a X-shaped beam arrangement that includes a rear pair of beams with laterally spaced first beam ends that each merges with said frame rear portion and with second beam ends that merge with each other at a joint, said X-shaped beam arrangement having a front pair of beams with first ends that merge with said joint and with laterally spaced second ends on which said fingers are mounted.

12. The frame described in claim 10 wherein said frame has a pair of primarily laterally extending beams with free ends, said fingers being mounted on said free ends, and wherein:
said beam free ends have stops that each abuts said panel at a location adjacent to a corresponding one of said fingers.
